(19) United States
(12) Patent Application Publication
(10) Pub. No.: US 2004/0167985 A1
(43) Pub. Date: Aug. 26, 2004

(54) Internet protocol access controller

(75) Inventors: Peter Jamitzky, San Jose, CA (US); Jacek Jamicki, Rybnik (PL); Pawel Jewstafjew, Lublin (PL); Daniel Lazarek, Chorzow (PL)

Correspondence Address: Peter Jamitzkv, 5712 Condor Circle, San Jose, CA, 95118, US

(73) Assignee: Adescom, Inc.

(21) Appl. No.: 10/371,444

(22) Filed: Feb. 21, 2003

(51) Int. Cl. G06F 15/16

(52) U.S. Cl. 709/230

(57) ABSTRACT

A network protocol processing circuit for processing TCP/IP (Transmission Control Protocol/Internet Protocol) tasks include first and second circuit portions. The first circuit portion has a plurality of protocol modules implemented in hardware. The second circuit portion has a controller operated by software. The TCP/IP tasks are partitioned and classified into critical and non-critical tasks. The hardware-implemented first circuit portion processes the critical tasks while the software-operated second circuit portion tackles the non-critical tasks, which includes directly bidirectionally transferring data between the network protocol processing circuit and an externally attached media device without passing through any external host processor.

### BACKGROUND OF THE INVENTION

1. Field of the Invention

The present invention generally relates to network protocols, and more particularly, to the TCP/IP (Transmission Control Protocol/Internet Protocol) implementation in computer and communications networks for high throughput data transmission.

2. Description of the Related Art

The TCP/IP set of protocols has been widely used in communications and data networks. In many embedded applications, the use of the TCP/IP connectivity is a standardized requirement. Examples of such embedded applications include voice-over-IP and video-over-IP. These embedded applications require the TCP/IP implementation to be small in physical size, easy to use, yet with high throughput data exchange rates in excess of tens of Mb/s (Mega bits per second). Another feature of such embedded application is that this high throughput data flow is directed by a low-performance user processor.

For instance, in a system having an audio-video device generating a digital video-audio stream connected to a TCP/IP network, conventionally, a user processor is used to direct the data traffic flow. In this case, the user processor operates both a user application and the TCP/IP stack, bidirectionally transporting the audio-video data between the application and the TCP/IP network. Execution the TCP/IP stack and mediating the data between the TCP/IP network and the user application are very intensive in terms of processing power. Consequently, only a fast, expensive, and sophisticatedly-implemented user processor can efficiently manage such operations. The need to implement those expensive user processors practically excludes many electronic devices. Examples of such price sensitive devices are: video-enabled appliances, content distribution devices, or network hard disk drives.

In general, any implementation of the TCP/IP set of protocols that targets embedded applications has to meet two competing requirements. One the one hand, the implementation has to be small in physical size, simple, and cost effective. On the other hand, the implementation must be capable of handling high data throughput with low or no involvement of the user processor. To address the aforementioned problem, various schemes have been proposed. They all can be grouped into the following three classes: pure software solutions, mixed software-hardware solutions, and pure hardware solutions.

In the pure software solution, a powerful user processor implements the complete TCP/IP stack. As mentioned before, a powerful processor is costly and complicated to implement. Further, most embedded processors are not fast enough to support the TCP/IP throughput rates in excess of 10 Mb/s. Additionally, in the pure software solution the complete high throughput data traffic is relayed through the user processor, thus further aggravating the problem.

The second solution class is a mixed software-hardware approach. Here, the congestion in high throughput TCP/IP connectively is alleviated by partitioning the implementation of the TCP/IP stack between a user processor and a dedicated TCP/IP hardware accelerator. In this combination, the TCP/IP stack is predominantly executed in software by the user processor, and only the most critical parts are off-loaded to the hardware accelerator. Because the user processor still has to execute parts of the TCP/IP stack, the amount of processing power left for other user application varies with actual network and traffic conditions. This is a serious disadvantage of this solution.

The third solution class is a pure hardware approach. Implementation of a complete TCP/IP stack in hardware makes the overall system generally impractically complicated and physically large. For that reason, to curtail complexity and cost, available hardware implementations of the TCP/IP support only a subset of the required TCP/IP set of protocols, leaving other portions of the TCP/IP stack, such as the ARP (Address Resolution Protocol), ICMP (Internet Control Message protocol), DHCP (Dynamic Host Configuration Protocol), or IGMP (Internet Group Management Protocol) to be handled by the user processor.

Designs which offer low throughput rates are mostly accomplished by software solutions in which the software codes operate on general-purpose microprocessors. Software implementations of the TCP/IP set of protocols on general-purpose processors are based on available documents from Internet Engineering Task Force (IETF), a TCP/IP standardization organization. Several software implementations are widely available as a public-domain shareware. The advantage offered by software implementations is that they have a very well-defined interface. The disadvantage, on the other hand, is a limited throughput. To improve the throughput rate, a powerful and costly processor must be used. This is all pointed out by Douglas E. Corner and David L. Stevens, TCP/IP. Client-Server Programming and Applications, Prentice Hall, N.J., 2001, Vol 3. While describing the TCP/IP server applications, Corner and Stevens indicate that the computing overhead required to support the TCP/IP stack, including the socket interface is substantial. Commercial products also show this limitations: Dallas Semiconductors outlined in “Embedded Systems Programming” Vol 16, Number 1, that their 8-bit processor can process at maximum a 5 Mb/s Ethernet data stream, leaving no computing power to any user applications. The computing overhead of a software implementation is also addressed in U.S. Pat. No. 6,434,620, Boucher et al., entitled, “TCP/IP Offload Network Interface Device,” issued Aug. 12, 2002.

Designs which offer high throughput rates are mostly accomplished by hardware, specifically, via implementation of gate-level circuitry or dedicated network processors. An example of a gate-level implementation is disclosed in U.S. Pat. No. 6,034,963, Minami et al., entitled, “Multiple Network Protocol Encoder/Decoder and Data Processor,” issued Oct. 31, 1996. Pure gate-level circuitry solutions, such as taught in Minami et al., support only a subset of the TCP/IP stack. They are very inefficient in the implementation of a configuration-oriented part of the TCP/IP stack, such as DHCP, ARP, ICMP, IGMP, or DNS. A pure hardware implementation of this configuration-oriented part is not only complicated and costly as mentioned, but it results in hardware circuit portions that are not continuously operating but instead idle dormant most of the time.

There are schemes that partition the TCP/IP processing tasks by splitting network communications between a user host processor and a specialized, dedicated network protocol accelerator. An example of such an implementation is disclosed in Boucher et al., supra. In Boucher et al., the protocol accelerator basically off-loads the user processor from the tasks of header processing and checksum computations, yet leaving all slow but complicated paths of the TCP protocol to the user processor. Consequently, only the off-loaded tasks are accelerated. The resulting off-loaded tasks, even though accelerated, are unable to cope with some real network conditions beyond certain basic network configurations and are prone to the additional communication overhead between the accelerated and non-accelerated parts. For example, Boucher et al. lists a number of protocol tasks, such as a sliding window mechanism for software implementation on the host processor, which are excluded from acceleration. The burden of those excluded tasks is eminent in network communications other than LANs (Local Area Networks), as for example WANs (Wide Area Networks) or MANs (Metropolitan Area Networks) which are more exposed to unreliable delivery conditions. Publications are abound in this respect as exemplified by the work of W. Richard Stevens in TCP/IP Illustrated: The Protocols, Vol 1; Douglas E. Corner in Internetworking with TCP/IP: Principles, Protocols, and Architectures, Vol 3; and Douglas E. Comer in Traffic Engineering for Voice over IP, Business Communications Review, September 2002. Furthermore, in Boucher et al., the fact remains that, despite the dedicated network protocol accelerator takes over part of the TCP/IP processing tasks, the user processor has still to process the TCP/IP stack, in addition to its normal duty. Consequently, the user processor is substantially burdened. This is particularly true in applications involving small data packets and multiple opened TCP connections.

There is yet another approach as exemplified by U.S. Pat. No. 6,141,705, Anand et al., entitled “System for Querying a Peripheral Device to Determine its Processing Capabilities and then Offloading Specific Processing Tasks from a Host to the Peripheral Device When Needed,” issued Oct. 31, 2002. In Anand et al., all protocol tasks are executed by the software, by off-loading protocol processing task during peak times to dedicated hardware peripherals. The drawback of this approach is that two types of implementations, that is, both software and hardware, independently of each other need to implement a full TCP/IP stack. The need to allocate two different resources to run the same protocols results in higher costs and complexity.

There are also some other schemes, such as disclosed in U.S. Patent Application Publication Nos. 20020095511 by Walker Ted W., and 20020004842 by Ghose Kanad at al, to tackle the aforementioned problem by overhauling or modifying the TCP/IP set of protocols so as to suit low processing overhead. Such modifications, even if implemented, may not be compatible with current standards and abridging some important functions.

Finally, there is no solution which combines a cost-effective processing of high throughput TCP/IP stack with relaying the processed data directly to destination devices, without any involvement of the user processor.

Electronic products connecting to the TCP/IP networks are now built with ever-decreasing physical sizes and low power consumption, yet requiring more and more communication bandwidth. In many consumer products and embedded applications this requirement is combined with a restriction to deploy low-end user processors. In such TCP/IP-based applications there is a real need to provide practical and cost-effective solutions.

### SUMMARY OF THE INVENTION

It is the object of the invention to provide a network protocol processing circuit that processes all TCP/IP tasks with high data throughput. It is another object of the invention to provide such network protocol processing circuit that can automatically relay the data between the TCP/IP network and destination devices without any involvement of the user processor.

The network protocol circuit for processing TCP/IP tasks in accordance with the invention, includes a first and a second circuit portion. The first circuit portion has a plurality of protocol modules implemented in hardware. The second circuit portion has an internal controller operated by software. The split of the network protocol processing circuit into the first and the second unit corresponds to partitioning of the TCP/IP stack into critical and non-critical tasks. Critical tasks include processing of protocols that involve data packets and other tasks related to relaying the data packets between the network protocol circuit and any externally attached media device without passing through any user processor. Those critical tasks are handled by the first circuit portion. Non-critical tasks include processing less critical protocols and other tasks such as network management, configuration and maintenance processing. All those non-critical tasks are processed by the second circuit portion. As arranged, the user processor is relieved of any TCP/IP tasks.

### BRIEF DESCRIPTION OF THE DRAWINGS

FIG. 1 is a block diagram showing the architectural design of the invention;

FIG. 2 is a block diagram showing a more detailed version of the block diagram shown in FIG. 1;

FIG. 3 is a flow chart showing the software algorithm to be executed by the internal controller of the invention; and

FIG. 4 is a block diagram illustrating an application of the invention in which user data are forwarded to direct media interfaces bypassing any user processor.

### DETAILED DESCRIPTION OF THE INVENTION

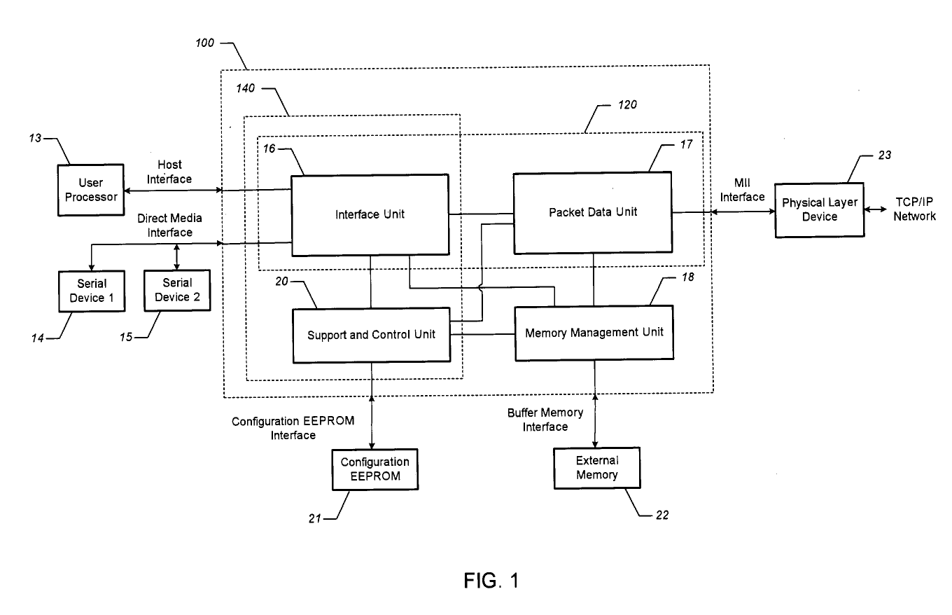

Reference is now directed to FIG. 1 which shows a preferred embodiment of the invention. In this embodiment, the preferred embodiment is called an IPAC (Internet Protocol Access Controller), which is generally signified by the reference numeral 100. The IPAC 100 of the invention basically includes four units, namely, a user interface unit 16, a packet data unit 17, a software processing unit 20, and a memory management unit 18. In this embodiment, the data packet processing unit 17 is assigned to critical tasks involving user data processing. The software processing unit 20 is assigned to non-critical and will be further described later.

The user interface unit 16 and the packet data unit 17 together form a main data-processing chain are signified by the reference numeral 120. This chain 120 processes all user data packets. User data packets from the chain 120 can bidirectionally communicate with an external host 13 or serial devices 14 and 15.

There is a second processing chain, denoted by the reference numeral 140, which constitutes the user interface unit 16 and the support and control unit 20. This chain 140 is put in place to process user commands and to execute those parts of the TCP/IP stack which do not operate on user data packets. The support and control unit 20 is also designed to read an initial configuration from a configuration EEPROM (Electrically Erasable Programmable Read Only Memory) 21 which is tied thereto. The packet data unit 17 is coupled to the support and control unit 20.

The memory management unit 18 is coupled to all the units, that is, the interface unit 16, the packet data unit 17 and the support and control unit 20, to allow all the units 16, 17, and 20 to get access an external buffer memory 22.

In accordance with the invention, in this embodiment 100, the user interface unit 16, packet data unit 17, and memory management unit 18 are implemented in hardware, that is, as a gate-level hardware. On the other hand, the support and control unit 20 is software driven. That is, the support and control unit 20 is designed to be operated by software codes.

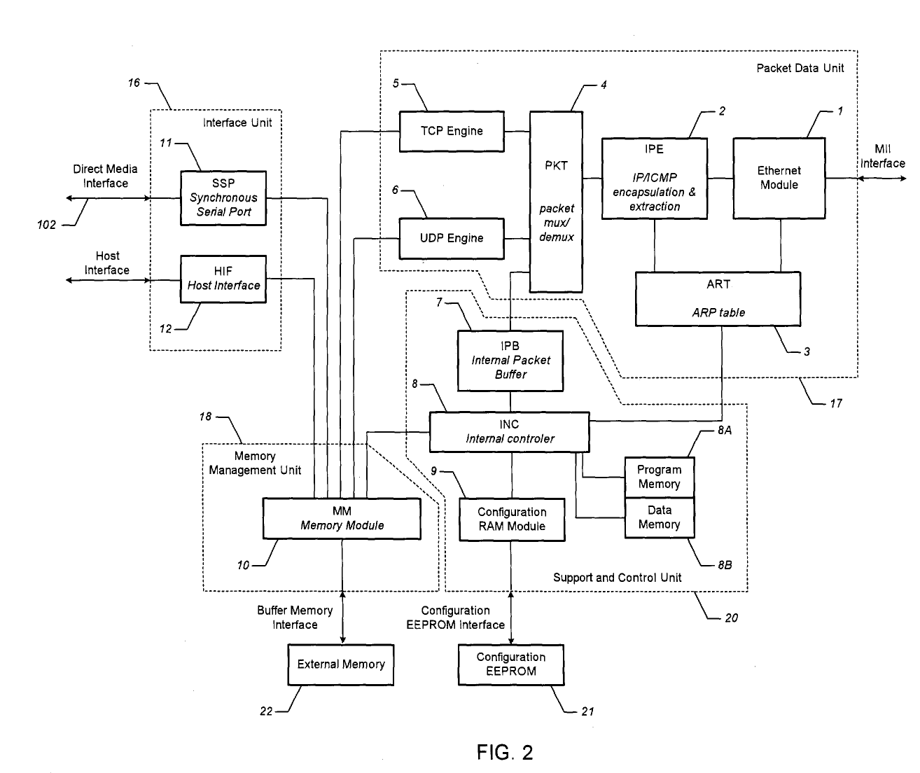

FIG. 2 is another block diagram drawing which shows a more detailed illustration of each of the units 16, 17, 18 and 20. Their structures are herein described.

The packet data unit 17, among other things, includes a plurality of hardware modules. In this specification and the appended claims, the term module is construed to be a hardware or software sub-unit or sub-entity. The actual components in a module need not to be physically placed together and can be scattered. Returning to FIG. 2, the packet data unit 17 includes an Ethernet module 1 coupled to an IP module 2, which in turn is tied to a packet multiplexer 4 on the one side. A TCP engine 5 and an UDP engine 6 are connected to the multiplexer 4 on the other side. An ART (Address Resolution Protocol Table) module 3 is also disposed to attach to the IP module 2 and the Ethernet module 1. With the exception of the multiplexer 4, each module within this unit 17 is assigned to execute a particular protocol of the TCP/IP stack. More specifically, the assigned protocols processed by the protocol modules are considered as critical in terms of execution speed. Each of these modules can fully execute the protocol which it is assigned. Thus, in this embodiment, the Ethernet module 1 implements the data link layer; the IP module 2 implements the IP network layer; the TCP engine 5 implements the TCP transport layer; and the UDP engine 6 implements the UDP transport layer. Detailed specifications and descriptions of these protocols are available from the IETF, the Internet standardization organization which currently maintains a website: www.ietf.org. From the IETF, the Ethernet protocol is described in the standard RFC894; the IP protocol is described in RFC793; the UDP protocol is described in RFC768; and the TCP protocol is described in RFC793. The access control of the Ethernet protocol is described in IEEE802.3, which protocol in turn is available on the IEEE (International Electrical and Electronic Engineers), a professional organization. The IEEE also currently maintains a website: www.ieee.org.

Modules 1, 2, and the multiplexer 4 form a chain in which data packets are processed serially. The packet multiplexer module 4 is a data traffic multiplexer which has data paths to the TCP engine 5, the UDP engine 6 and the internal packet buffer 7. During operation, the multiplexer module 4 forwards the data packets to other appropriate modules. For example, TCP datagrams are transmitted to the TCP engine 5; UDP datagrams are transmitted to the UDP engine 6; and any remaining datagrams are transmitted to the internal packet buffer 7.

The TCP and UDP engines 5 and 6 maintain look-up tables, which hold the most frequently used parameters of each opened communication channel.

The user interface unit 16 exchanges user data and controls the IPAC 100. In this embodiment, the user interface unit 16 includes two interface circuits, namely, a synchronous serial port 11 and a host interface 12. The synchronous serial port 11 provides a connection to external serial devices (not shown). The host interface 12 connects to a user processor (not shown). While the synchronous serial port 11 can only exchange user data, the host interface 12 can both exchange user data and control the IPAC 100.

The support and control unit 20 controls the operation of all three units 16, 17 and 18. Furthermore, the support and control unit 20 processes certain TCP/IP protocols with slow executions that do not deteriorate the user data throughput. The support and control unit 20 comprises an internal controller 8 disposed between an internal packet buffer 7 and a configuration RAM 9. The internal controller 8 is the main part of the support and control unit 20, while the buffer 7 and the configuration RAM 9 provide support functions. The buffer 7 buffers incoming and outgoing data packets. The configuration RAM 9 off-loads the internal controller 8 from any parallel-to-serial and serial-to-parallel conversions, which conversions are necessary to communicate with an external serial EEPROM 21. In this embodiment, the internal controller 8 is implemented as an 8-bit general-purpose processor, which has a program memory 8A and a data memory 8B. The program memory 8A holds the software which is executed by the internal controller 8. The data memory 8B provides space for variables which are necessary for the execution software.

As mentioned previously, in the control and support unit 20, the software is run by the internal controller 8. More in particular, the internal controller 8 executes TCP/IP protocols that are non-critical in terms of speed. Furthermore, the control and support unit 20 processes non-critical tasks such as network management, configuration and maintenance. For example, the internal controller 8 in the control and support unit 20 interprets external commands, such as commands to open or close a channel, or commands to perform initialization after reset. The internal controller 8 does not execute any user software; this controller is predominantly and exclusively assigned to IPAC 100—oriented tasks.

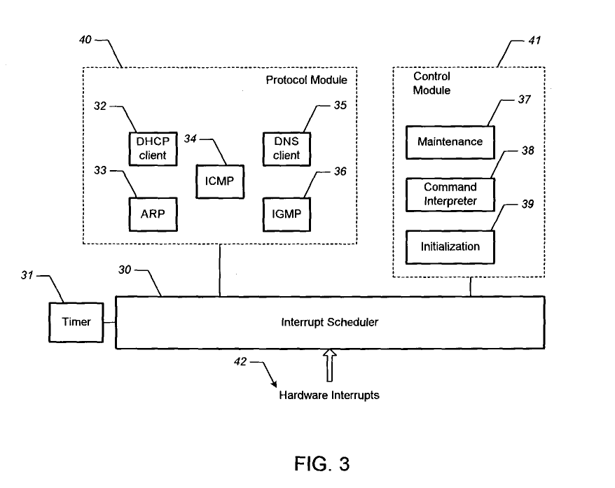

The general algorithmic structure of the software run by the internal controller 8 of the control and support unit 20 is illustrated in FIG. 3. The software algorithm basically includes an interrupt scheduler 30, a set of protocol subroutines 40, a set of control subroutines 41, and a subroutine of timer module 31. The interrupt scheduler 30 is deployed to allocate the execution flow of the internal controller 8 to either the set of protocol subroutines 40 or to the set of control subroutines 41. The execution flow can be changed based on events from the timer 31 or from hardware interrupts 42. The hardware interrupts 42 can be generated by the IPAC's hardware modules, such as the modules in the packet data unit 17.

The set of protocol subroutines 40 includes an ARP (Address Resolution Protocol) block 33, a DHCP (Dynamic Host Configuration Protocol) client block 32, an ICMP (Internet Control Message Protocol) block 34, an IGMP (Internet Group Management Protocol) block 36, and a DNS (Domain Name System) client block 35. Each block carries the name of a TCP/IP protocol it is implemented. In this embodiment, protocols in the set of protocol subroutines 40 implement protocol tasks which are characterized as non-critical, and are thus assigned to be processed via software by the control and support unit 20. Again, detailed specifications and descriptions of these protocols are available from the IETF as previously mentioned. In particular, the ARP protocol is described in the RFC826 standard; the DHCP is described in the RFC2131 standard; the ICMP is described in the RFC792 standard; the IGMP is described in the RFC 1112 and RFC2236 standards; and the DNS is described in the RFC 1035 standard.

The set of control subroutines 41 comprises an initialization module 39, a command interpreter 38, and a maintenance module 37. As structured, the purpose and function of the control modules subroutine 41 is to provide appropriate initialization of all hardware blocks, interpret external commands and maintain all internal resources.

The operation of the IPAC 100 in accordance with the invention is herein described. Reference is now directed to FIG. 1 in conjunction with FIG. 2. The IPAC 100 is essentially controlled by commands which have been parsed and executed by the internal controller 8 in the support and control unit 20. The command interface function performed by the internal controller 8 allows the user to operate at a high level of abstraction, leaving all the details to the IPAC 100. This high abstraction level can reduce a basic TCP/IP communication to two commands. The first command is to open a channel and indicate the type of a channel, that is, whether it is a TCP or an UDP channel. The second command is to send or receive data. All operations concerning the TCP/IP stack are performed internally within the IPAC 100. In particular, the user processor 13 is completely free for user applications. The IPAC 100 indicates when it is ready for the next portion of user data, or when the data has arrived from the network and is ready to be read. If during opening of a channel the user has indicated that the data should be terminated on the direct media interface 102, the data on that channel is automatically redirected to that interface 102, without being forwarded to the user processor 13. In this manner, even very slow user processors can control a large amount of data. Because directly after reset, the IPAC 100 can automatically perform the configuration from the configuration EEPROM 21, in some applications, there is even no need to operate the user processor 13.

Prior to operation, the IPAC 100 has to be initialized. The initialization process comprises two steps, namely, network initialization and setting up of the TCP/IP communication channels. The network initialization step requires first finding out the Ethernet address and the IP configuration. The Ethernet address is individually assigned to each network device and is stored in the configuration EEPROM 21. The process of finding out the IP configuration can be performed automatically by the DHCP client block 32 (FIG. 3). Alternatively, the IP configuration can also be stored in the EEPROM 21, in case when an external DHCP server is unavailable.

After the initialization step, the IPAC 100 is ready to open communication channels. For each opened channel, the internal controller 8 allocates internal resources and resets the protocol state machines. Thereafter the ARP module 33 (FIG. 3) resolves the next hop Ethernet address, and the channel is ready to accept the data. While opening a channel, the IPAC 100 assigns to the channel a unique channel identifier. For TCP channels, this identifier together with the following channel parameters is stored in a TCP look-up table. For UDP channels, this identifier is stored in a UDP look-up table. The look-up tables have information about the read and write pointers to the channel buffer in the buffer memory 22, whether there is data to be read or whether the buffer is full, states of TCP or UDP protocol state machines, local and remote port numbers, remote IP address, and whether the channel data is targeted to the external host processor 13 or to the direct media interface 102. This information is frequently used, so that it is stored in the local look-up tables and not in the buffer memory 22.

Data packets arriving from the network are first processed by the physical layer device 23 and the Ethernet module 1. Frames with Ethernet addresses being neither broadcast, nor valid multicast, nor IPAC's unicast Ethernet address are discarded. After being processed by Ethernet module 1 in accordance with the RFC894 and IEEE802.3 standards, the Ethernet frame header is removed. The resulting data packet is forwarded to the IP module 2. The IP module 2 processes all data packets, with the exception of ARP frames. The ARP frames are not IP datagrams and therefore they are forwarded directly to the packet multiplexer 4. All other packets are processed in accordance to the IP protocol described in RFC793. In particular, IP data packets with IP addresses not being a broadcast, valid multicast, or IPAC's unicast Ethernet address are discarded. The IP module removes the IP header and forwards the remaining payload to the packet multiplexer 4. The packet multiplexer 4 then distributes the data packets either to the internal controller 8 or to other processing blocks. The ARP, ICMP, DHCP client, DNS client, and IGMP packets are forwarded to the internal controller 8. UDP packets are forwarded to the UDP engine 6. TCP packets are forwarded to the TCP engine 5. In the above mentioned processes, the data packets are processed in accordance to the following underlying protocols: the ARP in accordance with RFC826, the ICMP in accordance with RFC792, the DHCP client in accordance with RFC2131, the DNS client in accordance with RFC1035, the IGMP in accordance with RFC1 112 and RFC2236, the UDP in accordance with RFC768, and the TCP in accordance with RFC793.

After the protocol-oriented processing, the TCP or UDP data packets are stored in buffer memory 22. All other packets are processed and terminated by the internal controller 8. While writing the data into the buffer memory 22, the IPAC 100 updates the corresponding channel entry in the look-up table. After this update, the entry indicates that the opened channel has data ready to be read.

Once the read data is stored in the buffer memory 22, it is ready to be forwarded either to the external host processor 13 or to the direct media interface 102. For that purpose, the host interface 12 and the synchronous serial port 11 scan the look-up tables for the channels which have data ready. If the arrived data belong to a channel that has been assigned to the direct media interface 102, it is automatically relayed to the media interface 102, thus bypassing the external host processor 13. In all other cases, the IPAC 100 indicates to the external host processor 13 that the data are available. The external host processor 13 can in turn read the data, along with a channel identifier.

In the reverse direction, that is, from the user to the TCP/IP network, the IPAC 100 begins the operation by gathering data that arrive from two sources, namely, the external host processor 13 and the direct media interface 102. Data that arrive from the external host processor 13 is accompanied by a channel identifier. In this way, the IPAC 100 can store the data in the appropriate buffer. Data that arrive from the direct media interface 102 has a fixed binding between a time slot number of the direct media interface and IPAC's internal channel number. This binding allows the IPAC 100 to immediately recognize the appropriate channel buffer and then store the data in the channel buffer. Having resolved channel identifiers of all arriving data, the IPAC 100 forwards the data to the appropriate processing engines. For example, all UDP channels are sent to the UDP engine 6. All TCP channels are directed to the TCP engine 5. The UDP and the TCP engines process the data in accordance to the corresponding protocols: the UDP in accordance with RFC768, and the TCP in accordance with RFC793. These protocols may be required to perform transitions in the protocol state diagrams irrespective of the input or output traffic. Examples of such transitions are: confirmations of arrived data, or data packet retransmissions even when the user does not have any new data to send. Because these engines are implemented in hardware, any additional activity is performed in parallel to the regular data transfer. The resulting UDP and TCP data packets are then forwarded to the multiplexer module 4. The multiplexer module 4 also gathers data packets from other protocols, which originate from the internal controller 8, such as the ARP 33, the ICMP 34, the DHCP client 32, the DNS client 35, and the IGMP 36. As previously mentioned, these protocols reside in the program memory 8A and are executed by the internal controller 8 in accordance with the following standards: the ARP in accordance with RFC826, the ICMP in accordance with RFC792, the DHCP client in accordance with RFC 2131, the DNS client in accordance with RFC 1035, and the IGMP in accordance with RFC 1112 and RFC2236.

Thereafter, the packet multiplexer 4 forwards the data packets to the IP module 2. The IP module 2 then provides the necessary processing in accordance with the RFC791 protocol, and additionally resolves the next hop Ethernet address by sending a request to the ART module 3. The Ethernet address resolution is performed in advance, so that when the data packet reaches the Ethernet module 1, the Ethernet address has already been resolved. Because the ARP data packets are not encapsulated into any IP structure, the IP module 2 bypasses them directly to the Ethernet module 1.

The Ethernet module 1 processes the incoming data packets according to the RFC894 and IEEE802.3 standards. Specifically, an Ethernet header is appended and access rights to the physical layer are resolved. Finally, the data packet is sent to physical layer device 23, and from there to the TCP/IP network.

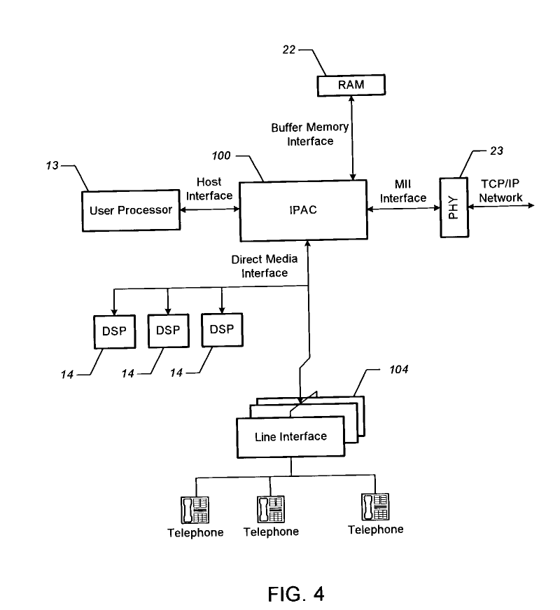

Shown in FIG. 4 is an exemplary application of the IPAC 100 in accordance with the invention. Specifically, it is an example of a voice-over-IP. In this example, the external user processor 13 is not only incapable of processing the TCP/IP stack on a multitude of connections, but the user processor 13 does not have the required performance to move user data to and from serial devices 14. The only task assigned to the user processor 13 is to run an application which decides whether a channel has to be opened or closed. After instructed to open a channel by the user processor 13, the IPAC 100 autonomously operates the TCP/IP stack, based on a DNS protocol finds the remote IP address and exchanges data with serial devices 14, all done without any interaction with the user processor.

As described, the IPAC 100 implemented in accordance with the invention off-loads the TCP/IP stack from the user processor 13 and completely removes the user processor 13 from any TCP/IP-oriented protocol processing. Accordingly, the user processor 13 is completely free of any TCP/IP processing. Regarding the off-loaded TCP/IP stack, selection is further made such that critical operations are assigned to the protocol modules unit 17 which is hardware based. Less critical operations are tackled by the support and control unit 20 which is software operated. The split between hardware and software as proposed in the invention is optimal in regard of the underlying complexity and size. Consequently, the entire IPAC 100 can be built with reduced complexity, lower power consumption and above all, at a reduced cost.

Finally, the embodiment described above includes many specificities, which should not be construed as limiting the scope of the invention but merely as illustration. Changes are possible within the scope of the invention. For example, in configurations which do not require any UDP processing, the UDP engine may be dispensed. Furthermore, some applications may require only a host interface, yet others may require only a direct media interface, and still some may need both. Software that runs the internal controller 8 need not be coming from any memory circuits within the IPAC 100, such as the program memory 8A, but from an external source. It will be understood by those skilled in the art, that these and other changes in form and detail may be made therein without departing from the scope and spirit of the invention.

What is claimed is:

1. A processor circuit for processing TCP/IP network protocols, comprising:
a first circuit portion having a plurality of protocol modules which are hardware implemented; and
a second circuit portion having an internal controller coupled to said first circuit portion, said controller being operated by software;
wherein said network protocols include protocol tasks which are characterized as critical and non-critical tasks, such that said critical tasks are processed by said protocol modules in said first circuit portion and said non-critical tasks are processed by said controller in said second circuit portion, said internal controller being disposed in said second circuit portion predominantly and exclusively for the processing of said non-critical tasks.

2. The processor circuit of claim 1 wherein said protocol modules include an IP module.

3. The processor circuit of claim 1 wherein said protocol modules include an Ethernet module.

4. The processor circuit of claim 1 wherein said protocol modules include an ART module.

5. The processor circuit of claim 1 wherein said protocol modules include a TCP engine.

6. The processor circuit of claim 1 wherein said protocol modules include an UDP engine.

7. The processor circuit of claim 1 wherein said critical tasks include processing of data packets and said non-critical tasks include processing of network management, configuration and maintenance.

8. The processor circuit of claim 1 further including an interface circuit portion coupled to said first and second circuit portions, said critical tasks further including directly bidirectionally transferring data between said processor circuit and said interface circuit portion.

9. The processor circuit of claim 1 wherein said second circuit portion further including a memory module for storing codes of software which operates said internal controller.

10. An apparatus for processing TCP/IP network protocols for transmitting and receiving data from a data network, comprising:
a packet data circuit having a plurality of protocol modules which are implemented in gate-level hardware; and
a control and support circuit having an internal controller coupled to said packet data circuit, said internal controller being configured to be operated by software;
wherein said TCP/IP network protocols include protocol tasks which are partitioned and characterized as critical and non-critical tasks, such that said critical tasks are processed by said packet data circuit and said non-critical tasks are processed by said internal controller, said internal controller being included in said control and support circuit predominantly and exclusively for the processing of said non-critical tasks.

11. The apparatus of claim 10 wherein said protocol modules in said packet data circuit includes an IP module for constructing IP datagrams during said data transmitting and for analyzing IP datagrams during said data receiving.

12. The apparatus of claim 11 wherein said protocol modules in said packet data circuit further including a protocol engine layer coupled to said IP module.

13. The apparatus of claim 12 wherein said protocol engine layer includes a TCP engine and an UDP engine.

14. The apparatus of claim 12 wherein said protocol modules in said protocol modules circuit further including a data packet multiplexer and demultiplexer disposed between said protocol engine layer and said IP module.

15. The apparatus of claim 14 wherein said protocol modules in said protocol modules circuit further including an Ethernet module coupled to said IP module.

16. The apparatus of claim 15 wherein said Ethernet module and said IP module have an ART module attached thereto.

17. The apparatus of claim 16 further including a data interface circuit coupled to said protocol engine layer and said controller, said data interface circuit includes a serial or a parallel port configured to connect to external media and a host interface configured to connect to an user processor, said critical tasks include directly bidirectionally transferring data between said apparatus and said serial or parallel port.

18. The apparatus of claim 17 further including a memory circuit disposed between said data interface circuit and said internal controller.

19. The apparatus of claim 16 wherein said control and support circuit further including an internal packet buffer and a configuration RAM module, said internal controller being disposed between said internal packet buffer and said configuration RAM module, said internal packet buffer being coupled to said data packet multiplexer and demultiplexer, said configuration RAM module being coupled to a configuration EEPROM which is external to said control and support circuit.

20. An apparatus for processing TCP/IP network protocols in a communications network, comprising:
an interface circuit having a serial or a parallel port configured to connect to external media devices and a host interface module configured to connect to a user processor;
a packet data circuit coupled to said interface circuit, said packet data circuit includes a plurality of protocol modules which are implemented in gate-level hardware, said interface circuit and said packet data circuit constitute a first processing path for processing said network protocols which are characterized as critical and data packets in said communications network, and
a control and support circuit coupled to said interface circuit, said control and support circuit includes a controller which is configured to be operated by software, said interface circuit and said control and support circuit constitute a second processing path for processing said network protocols which are characterized as non-critical and the management, configuration and maintenance tasks of said communications network;
wherein said first and second processing paths being configured and dedicated to process said network protocols of said communications network, thereby substantially releasing said host processor of processing of any of said network protocols.

21. The apparatus of claim 20 further including a memory circuit coupled to said protocol modules circuit, said control and support circuit and said interface circuit.

22. The apparatus of claim 20 wherein said controller circuit being further configured to be operated by software to directly bidirectionally transfer data between said apparatus and said serial port without passing said user processor.
